(19) United States
(12) Patent Application Publication
(10) Pub. No.: US 2004/0088569 A1
(43) Pub. Date: May 6, 2004

(54) Apparatus and a method for securely switching status of a computing system

(76) Inventor: Tong Shao, Nanjing Jiangsu (CN)

Correspondence Address: Raymond Y. Chan, Suite 128, 108 N. Ynez Ave., Monterey Park, CA, 91754, US

(21) Appl. No.: 10/693,224

(22) Filed: Oct. 24, 2003

(30) Foreign Application Priority Data
Apr. 27, 2002 (WO) PCT/CN02/00299

(51) Int. Cl. H04L 9/00

(52) U.S. Cl. 713/200

(57) ABSTRACT

The invention is an apparatus and methods realizing secured switch of computing system status. Explanatorily, the switch control unit responds to status switch requests and sends out NMI to CPU; CPU responds to the interrupt signals and processes secured switch control programs; through the stated switch control unit, the stated switch connection unit completes the switch connection alternatively to one of the two stated state save units; after processing the interrupt service program, the stated switch control unit notifies the stated CPU to resume the data stored in the alterable state registers of the computing system before the interrupt; thus the computing system can be safely switched between different operation systems, or internal and external networks.

### BACKGROUND OF THE PRESENT INVENTION

2. Field of Invention

The invention relates to an apparatus and a method for securely switching status of a computing system, and more particularly, to the apparatus and the method wherein the status of the computing system is able to be switched only through a status switch apparatus thereof having authentication.

2. Description of Related Arts

At present, in consideration of information security, an internal network such as an office or a confidential Local Area Network, is usually physically separated from external network such as the Internet. Some home PCs having private data also need physical separation from the external network. The earliest predecessor solution to this problem was using two computers respectively connected to internal and external networks. Bringing high security however requiring two computers, it is too expensive and can not efficiently exchange data between the internal and the external networks. A later resolution was the dual-mainboard solution. Though uses a common computer chassis and shares one display and one keyboard, it still employs two computers essentially. It has the same problem as its ancestors.

Latterly, dual hard disk and then single hard disk solutions came up. The first one means that two hard disks are used by one computer. When using the internal network, a computer boots up with an “internal use only” hard disk and when it needs to be connected to the external network, a user can boot from the other hard disk connected and used by external network only. In this situation, once the external network is started up, the hard disk or network connected to the internal network is physically separated, i.e. the internal system is absolutely not accessible or at least is not able to be effectively read from or written on. Thus, a user is able to use either the internal system or the external system with one computer, with the physical separation of the internal and the external networks and consequent security of the internal data.

Although the solution of dual hard disk securely separated the internal and external networks, it requires two hard disks, which still costs relative high. In the single hard disk solution, the hard disk is divided into two divisions, each having its own operating system used independently by the internal or external network, respectively. A user can choose to boot either, the internal or the external network. In this solution, when the computer is connected to the external network, data of the internal network is not readable and/or writable and more than one operating systems need to be started up, as disclosed in the patented Chinese invention ZL 94,11,461 owned by the same inventor. When more than one operating systems need to be started up, a good way is “secondary startup” disclosed in Chinese patent ZL 97,116,855 of the same inventor. At the same time, the single hard drive solution also successfully solves the problem of system recovery when the system collapses. Additionally, in the solution, a swap area is established on the hard disk, which can be read from or written on when the external network is started up, or can be read from however without being written on when the internal is started up. Information is allowed to flow one-way from the external network to the internal, preventing any automatic disclosure of the internal data. The swap area can be arranged to be readable and writable at any time, which will sacrifice certain security performance. Generally, data exchanges between the internal and the external networks can flexibly and safely, keeping a secured separation is always desirable.

However, for either the single hard disk solution or the dual hard disk solution, if a user wants to switch between the internal and the external systems, the computer must be rebooted for purpose of security. It is obviously very inconvenient for users. Especially in e-business, a user frequently needs to communicate and exchange information with other external network users via the external network. And when he needs a digital signature, he may hope to enter the internal network where the signature key is placed to prevent any ill-willed hacker from getting it. After the information is safely signed, the user needs to come back into the external system to exchange the information with other relevant external network users. In that way, programs and keys for signature are kept in the internal system to ensure their security, and can only be used in e-commerce while security is guaranteed.

The most important issue in the Internet-based e-commerce is security. At client terminals, due to non-one-hundred-percent virus protection, ill-willed hacker invasions, and BOs, there exists the possibility for the information in client terminal computers to be illegally accessed. However, it is unaffordably serious if the information of a key used for digital signature, which is used to identify clients and sign contracts, is so accessed. It means the information of the key must be kept at an inaccessible place. An U.S. Pat. No. 99,806,523 filed on May 13, 1999 by Wave Systems Corp. disclosed a solution that employs a special-use computer for digital signature. But the computer, e.g. a smart card, either works slowly or is expensive, which makes the users have to choose encryption algorithms having relatively weaker performance. Therefore, the best way is to make full use of the computer at client terminal, making it 1. be able to physically separate the internal and the external systems, making any internal system information inaccessible from any program and individual including the user he himself; 2. when the computer is connected to internal network, the user can selectively send relevant information to the external system, and in order to ensure security, the control program will not be able to be changed by any virus: it should be write-protected; and, 3. the switching between the internal and the external systems should be conveniently and quickly.

The spirit of the invention for above mentioned computer can be applied to all computing systems such as the portable computing systems. A user may access the external network when internet communication is needed. When digital signature is needed, the user can enter the internal system, and then send documents bearing digital signatures to the expected destinations via external network.

A computer which is able to “simultaneously” use two operating systems will also provide convenience for computer education on multiple operating systems.

An apparatus for switching status of a computing system is disclosed in my another patent application. The apparatus having a status switching command input unit, a current status saving unit, a former status saving unit, a switching connection unit alternatively connected to one of the two status saving units and computing systems, and a switch control unit controlling alternative connection to one of the stated two status save sets. Through such apparatus to realize computing system status switch, the computing system can quickly switch between operation systems, and/or internal and external networks with the realization of physical separation between internal and external operation systems and networks. But, if virus or hackers have taken over the operation of status switch apparatus, the security of computing system will be damaged. Thus, an apparatus and methods that can realize switch of computing system status only through status switch apparatus with ID verification should be invented.

### SUMMARY OF THE PRESENT INVENTION

On one hand of the invention, an apparatus is provided to realize Secured switch of Computing system Status, including: request unit, to request computing system to switch from present status to the previous; switch unit, to realize status switch of the stated computing system; control unit, to ensure absolutely no interruptions of status switch process; the stated control unit responds to the requests out of request unit, controls the switch unit and transfers the computing system from present status to the previous one.

Preferably, the stated switch unit is an on-off device used to switch alternatively between the stated present and previous status as per the commands out of the control unit for the purpose of changing or resuming all the present alterable status information of the computing system.

Preferably, the control unit further includes an ID verification unit, which ensures that the switch can be executed only after ID verification.

Preferably, the control unit includes a memory to store all the control commands to complete status switch operations, and a monitoring unit to ensure that all the responses to switch requests can be executed only by the control commands stored in the memory. Otherwise, the switch unit will not work anymore.

Preferably, the control unit further includes: set trigger, to work as the symbol to allow normal operations of the switch unit and simultaneously send out NMI(non-maskable interrupt) to CPU in the computing system; reset trigger, to reinstall the set trigger after switching in case of being misemployed by any other programs.

Preferably, the control unit further includes an interrupt-monitoring unit, which ensures that the stated non-maskable program can not be interrupted by any means before the reset trigger ends its operation.

Preferably, the control unit includes: memory, to store control commands to complete status switch operations; and the unit forbidding any other programs to W/R all RAMs in the computing system to ensure that the only programs in the stated memory can be processed in the switching.

On the other hand of the Invention, the applicant invents a method to realize Secured switch of Computing system Status, including: a) to receive the request that the computing system be switched from the present status to the previous; b) to respond to the request and process a status switch control program that absolutely can not be interrupted; c) to switch the computing system from the present status to the previous saved one and change or resume all the present alterable status information of the computing system.

Preferably, step b) further includes the following step:

To ensure switch executed only after ID verification.

Preferably, step b) includes: d) to set symbols to allow normal switches and simultaneously send out NMI; c) to reinstall the stated symbols after a switch action in case of being misemployed by any other programs.

Preferably, the stated Step b) further includes the step: to ensure that the stated non-maskable program can not be interrupted by any means before the stated reset unit ends its operation.

Preferably, step b) includes: to ensure that all the responses to switch requests can be executed only according to the prearranged control programs. Otherwise, no switch will be allowed.

Preferably, step b) includes: to prohibit W/R all the RAMs of the computing system to ensure that the only programs stored in the stated memory can be processed in the switching.

### BRIEF DESCRIPTION OF THE DRAWINGS

Through the following illustrated optimal embodiments, the above-mentioned and other characteristics and strongpoint of the Invention stick out a mile.

FIG. 1 is the block diagram of the apparatus of an optimal embodiment based on the Invention.

### DETAILED DESCRIPTION OF THE PREFERRED EMBODIMENT

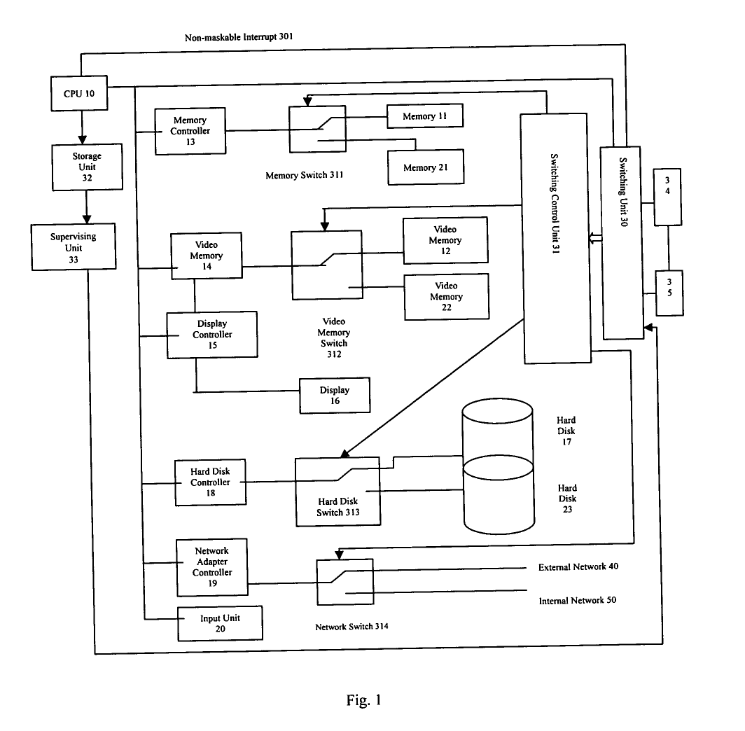

FIG. 1 illustrates the computing system of the embodiment based on the Invention. As known to computer practitioners, the operation status information of the computing system is stored in the corresponding memories. For example, the program addresses or data information of the present operation of the computing system are stored in the memory or buffer storage or other storages; the present display information of the computing system in its display memory. And the units of these storage status information are connected to respective control units, for instance, the memory to a memory control unit, and display memory to a display memory control unit, etc. The computing system of the Invention can be operated in two operation systems or in two completely different statuses. Therefore, two kinds of operation status information of the computing system can be found in the figure: one is to store present status information, and the other the previous status information or the next status information: two memories 11 and 21, two display memories 12 and 22, two hard disks 17 and 23, and the Internet 40 (external system) and local area network 50 (internal system), and so on, and respectively connected to unique memory control 13, display memory control 14, hard disk control unit 18, and network adapter unit 19, etc. The computing system also includes a CPU 10 to execute computing operations.

According to the embodiment of the Invention, the computing system also includes an apparatus to realize its secured switch between the above-mentioned two statuses. As showed in FIG. 1, the switch device is made up of a status connection switch unit 31, a status switch command input unit 20, and a secured switch control unit 30 to ensure absolutely no interrupts in the switching. The command input unit 20 receives the requests of the client and triggers a signal to notify the computing system to switch from the present status to the previous or next. The command unit 20 can be any one of command generating and input units, including buttons and keyboard. Secured switch control unit 30 receives status switch request signals from input unit 20, and as a response, the secured switch control unit 30 will send out a NMI to the stated CPU 10, and the stated CPU 10 will respond to it and execute an interrupt processing program prearranged by the secured switch control unit 30 to execute the status switch and save the data in the alterable status register in the present status, such as present Internet information, including addresses, pages, and other actions of the client, etc.; after saving, it will execute switch actions sent out by the stated connection switch unit 31; and the connection switch unit 3i will control the switch of computing system between he two status. To be specific, for example, as per the switching process, under the control of secured switch control unit 30, the connection of display memory control 14 to present display memory 12 will be switched to display memory 22, the connection of hard disk control unit 18 to hard disk 17 switched to hard disk 23, and connection of network adapter unit 19 to Internet 40 switched to local area network or the internal system 50, etc.

In the switching process, switching unit 30 ensures that the status switch process absolutely can not be interrupted, namely the switching process is for sure a primitive one, and then ensures CPU 10 not to process any other programs in the switching process.

After processing the interrupt service program, the stated secured switch control unit 30 notifies the stated CPU 10 to read all the storage devices with previous status information that are connected after switching, resume the data in the alterable state registers of the previous status of the computing system and then finish the switch from one operation system to the other, or from the internal system to external system, or between any two possible different status.

Alternatively, after processing the interrupt service program and the connection switch unit 31 finishing its switch, connection and control, the switching unit 30 notifies the stated CPU 10 to execute another operation system or enter a new service.

In the embodiment of the Invention, the switch control unit 31 can be an electric switch or a mechanical switch, which will switch between the present status and the previous as per the commands from secured switch control unit 30 to change or resume all present alterable status information of computing system.

It should be understood that although the embodiment employs CPU 10 of the computing system to execute an interrupt processing program and complete the switch, a processing unit with computing function can be integrated into switching unit 30 to process the program, which can make it free from its dependence on CPU 10 in the computing system.

Preferably, in the embodiment of the Invention, switching unit 30 should include an ID verification unit. When the client is identified as a legal user by the unit, the connection switch unit 31 will carry on the switching. Otherwise, further actions of connection switch unit 31 will be prohibited.

The computing system is basically the same with the unit of the embodiment 1, and same components are showed with same reference numbers, the difference is that in computing system 100′ the secured switch control unit 30 in the embodiment 1 is replaced by a monitoring unit 110 and memory ROM 11. In this embodiment, ROM 11 is stored with control commands to complete status switch operations, monitoring unit 110 receives switch requests from request unit 20, sends an interrupt control signal to CPU 10, and directs it to process the interrupt service program stored in ROM 11. At the same time, the unit 110 monitors the execution process of CPU 10 and confirms that the execution process of CPU 10 is always in n. primitive, a procedure code not allowed to be interrupted in the execution process, of the interrupt service program in order to ensure the only programs stored in ROM 11 to be processed. Otherwise, the connection switch unit 31 will not carry out any further operations.

In this embodiment, memory 11 is realized through ROM, but it can also be through any other memory units with write-protect function, such as RAM, Flash and so on.

Another embodiment based on the invention with the apparatus realizing secured switch of computing system status. As showed in the figure, the computing system is basically the same with unit of the embodiment 2, and same components are showed with same reference numbers, the difference is that computing system also includes a set trigger 34 connected to the stated monitoring unit 110. As the symbol allowing normal switch of the connection switch unit 31, the set trigger sends out NMI to the CPU of the computing system. In the switching process, connection switch unit 31 can determine whether to execute normal switch through reading the symbol of the set trigger. Also a reset trigger 35 is included, respectively connected to the monitoring unit 110 and set trigger 34. When the switch is finished, monitoring unit 110 will send a signal to reset trigger 35, and after receiving the signal, reset trigger 35 will reset the stated set trigger 34 and mask the switch function of connection switch unit 31 in case of being misused by any other programs for illegal switch.

Preferably, FIG. 1 illustrates a flow chart of the method to realize secured switch of computing system status based on the Invention. As showed in the figure, the method includes the following steps: 1) to receive status switch commands coming out of the stated status switch command input unit 20; 2) to send a switch request to switching unit 30; 3) the stated switch control unit 30 will respond to the switch request and judge whether the request has been verified; if verified, it will send out a NMI to the stated CPU 10, otherwise, the program will return to a waiting-on status; 4) the stated CPU 10 responds to the NMI and executes an interrupt service program which is ensured unalterable physically; 5) to save the data in the alterable registers of the computing system in present status, and then send a finish signal to the stated switch control unit 30; the stated switch control 30 will respond to the finish signal and send commands to the switch control unit 31 in the stated status switch unit 200, which will complete the switch connection to one of the stated two status save units via the stated switch control unit 31; 6) when the interrupt service program is executed, the stated switch control unit 30 will notify CPU 10 to resume the data in the alterable state registers of the computing system in the previous status.

Another flow chart of the method to realize secured switch of computing system status based on the Invention is disclosed. As showed in the figure, the method includes following steps: 1) to receive a status switch command coming out of the stated status switch input unit 20; 2) to send a switch request to a monitoring unit 110; 3) the stated monitoring unit will respond to the switch request and judge whether the request has been verified; if verified, it will send out a NMI to the stated CPU 10, otherwise, the program will return to the waiting-on status; 4) the stated CPU 10 responds to the NMI and executes an interrupt service program which is ensured unalterable physically; 5) the stated monitoring unit first verifies whether the interrupt service program in execution is the prearranged one stored in the memory and confirms that the computing system is working in n. primitive of the interrupt service program. If yes, the program will continue. If no, the program will exit; 6) to save the data in the alterable registers of the computing system in present status, and then send a finish signal to the stated monitoring unit 110; the stated monitoring unit 110 will respond to the finish signal and send commands to the switch control unit 31, which will finish the switch connection to one of the stated two status save units; 7) when the interrupt service program is executed, the stated monitoring unit 110 will notify CPU 10 to resume the data in the alterable state registers of the computing system in the previous status.

One more method to realize secured switch of computing system status based on the Invention is disclosed. The method includes following steps: 1) to receive a status switch command coming out of the stated status switch input unit 20; 2) to send a switch request to a monitoring unit 110; 3) the stated monitoring unit will respond to the switch request and judge whether the request has been verified; 4) if the ID verification is passed, a set signal will be sent to a set trigger, and then the set trigger will send a NMI to the stated CPU 10; 5) the stated CPU 10 responds to the NMI, executes an interrupt service program which is ensured unalterable physically; 6) the stated monitoring unit first verifies whether the interrupt service program in execution is the prearranged one stored in the memory and confirms that the computing system is working in n. primitive of interrupt service program. If yes, the program will continue. If no, the program will exit; 7) to save the data in the alterable registers of the computing system in present status, and then send a finish signal to the stated monitoring unit 110; the stated monitoring unit 110 will respond to the finish signal and send commands to the switch control unit 31, which will finish the switch connection to one of the stated two status save units; 8) upon receiving switch commands, switch control unit 31 will check the symbol of the set trigger and judge whether the switch connection should be executed; 8) after the execution of interrupt service program and switch connection, the monitoring unit 110 will direct reset trigger to send a reset signal to the set trigger; 9) the stated monitoring unit 110 will notify CPU 10 to resume the data in the alterable state registers of the computing system in the previous status.

In spite of the descriptions of the Invention in the above embodiments, it should be understood that the above descriptions are explanatory, but not restrictive. Under the precondition that the idea, thought and scope of the Invention are defined in the attached Claim of Rights, skilled practitioners in the field can make various modifications and changes.

What is claimed is:

1. An apparatus used to realize secured switch of computing system status, which includes:
request unit, to request the computing system to switch from the present status to the previous status;
switch unit, to realize status switch of the stated computing system;
control unit, to ensure the status switch process absolutely uninterruptible; and
the stated control unit responds to the requests from the request unit, and controls the switch unit to switch from the present status to the previous status.

2. As to the apparatus stated in claim of Rights 1, the stated switch unit is an on-off switch, which is used to switch selectively between the present and previous status of the computing system as per commands from the control unit in order to change or resume all the present alterable status information of the computing system.

3. As to the apparatus stated in claim of Rights 1, the control unit further includes an ID verification unit to ensure that the switch unit can execute its operation only after the ID verification.

4. As to the apparatus stated in claim of Rights 1-3, the control unit includes:
memory, to store the control commands to complete status switch operations;
monitoring unit, to ensure that the responses to status switch requests can be executed only by the control commands in the memory. Otherwise, the switch unit can not work.

5. As to any one of the units stated in claim of Rights 4, the control unit further includes:
set trigger, as the symbol to allow the switch unit to carry out its normal operations, and simultaneously sends out NMI to the CPU of the computing system;
reset trigger, to reset the stated set trigger after switching in case of being misused by any other programs.

6. As to the apparatus stated in claim of Rights 5, the control unit further includes an interrupt monitoring unit, which ensures that the stated non-maskable program can not be interrupted before finishing the reset of the stated reset trigger.

7. As to any one of the units stated in claim of Rights 1-3, the control unit includes:
memory, to store the control commands to complete status switch operations;
a unit forbidding to W/R all the RAMs in the computing system, to ensure that the only programs stored in the stated memory can be executed in the switching process.

8. A method to realize secured switch of computing system status, which includes:
a) to receive the requests to switch the computing system from the present status to the previous one;
b) to respond to the requests and execute a status switch control program that is absolutely uninterruptible with guarantee;
c) to switch the computing system from the present status to the stored previous one in order to change or resume all the alterable status information of the computing system.

9. As to the method stated in claim of Rights 8, the step b) further includes:
to ensure that the switch can be executed only after ID verification.

10. As to the methods stated in claim of Rights 7 or 8, the step b) includes:
d) to set symbols to allow normal switches and simultaneously send out NMI;
e) to reset the stated symbols after switching in case of being misused by any other programs.

11. As to the method stated in claim of Rights 9, the step b) further includes:
to ensure that the stated non-maskable program is absolutely uninterruptible before finishing he stated reset.

12. As to any one of the methods stated in claim of Rights 7-8, the step b) includes:
to ensure that the responses to status switch requests can be executed only by the prearranged control programs. Otherwise, no switch is allowed.

13. As to any one of the methods stated in claim of Rights 7-8, the step b) includes:
to forbid to read or write all the RAMs in the computing system, and ensure that the only programs stored in the stated memory can be processed in the switching process.
